(19) United States
(12) Patent Application Publication
(10) Pub. No.: US 2022/0209235 A1
(43) Pub. Date: Jun. 30, 2022

(54) ION CONDUCTIVE ASSEMBLY AND PROCESS FOR THE PREPARATION THEREOF

(71) Applicant: 3DBATTERIES LTD., Rehovot (IL)

(72) Inventors: Ester ABTEW, Jerusalem (IL); Doron BURSHTAIN, Herzliya (IL); Anica LANCUSKI, Haifa (IL); Erez SCHREIBER, Rishon Le Zion (IL)

(73) Assignee: 3DBATTERIES LTD., Rehovot (IL)

(21) Appl. No.: 17/593,788

(22) PCT Filed: Mar. 25, 2020
(86) PCT No.: PCT/IL2020/050352

§ 371 Date: Sep. 24, 2021

Related U.S. Application Data
(60) Provisional application No. 62/823,974, filed on Mar. 26, 2019.

(51) Int. Cl. H01M 4/62; H01M 10/0525; H01M 10/0565; H01M 4/04

(52) U.S. Cl. CPC H01M 4/62; H01M 10/0525; H01M 2300/0082; H01M 4/0404; H01M 10/0565

(57) ABSTRACT

Provided is an energy storage system constructed of an ion conductive assembly and electrodes.

### TECHNOLOGICAL FIELD

The invention generally concerns electrodes, ion conductive assemblies, and energy storage units comprising same.

### BACKGROUND

Most of the available lithium-ion energy storage devices use various forms of carbon as the electrode material (in lithium batteries graphite particles are used as an active material) and a commercial separator, such as Celgard, or a thin-film polymeric separator. The cathode active material can vary between various lithium salts and oxides such as LiFePO₄ (Lithium ferro phosphate), NMC (Lithium Nickel Manganese Cobalt oxide), NCA (Lithium Nickel cobalt aluminum oxide) and others. Each of the electrodes may also contain conductive additives such as carbon black, graphite, carbon nanotubes, reduced graphene oxide and others, and a binder which connects the particles to each other (cohesion), and to the current collectors (adhesion).

The structure of each of these electrodes and separator comprises, in most cases, two continues phases:
a solid phase (comprising the active material, conductive additives, and a binder); and
a continuous phase of free voids, which during operation are filled with the electrolyte solution. These voids exhibit a porosity of between 30%-43% for the electrodes, and 20-80% for the separation area.

This structure ensures full connectivity within the solid phase and between the solid phase and the current collector. A full connectivity of the electrolyte solution with the active material ensures full exploitation of the surface area of the active material, i.e. effective surface area for ion transport between the electrolyte solution and the active material and between the entire network of voids.

In recent years, silicon has been found to offer up to 10 times more energy density as compared to a carbon anode. However, silicon suffers from three major drawbacks:

(1) low electronic conductivity with a high electric conductivity variation between different state of charges (SOC), especially above 70% and below 5% SOC. This necessitates a considerable amount of conductive additives, which results in a massive solid electrolyte interface (SEI) built on their surface. As a result, degradation of the electrolyte and electrolyte solution ensues. In other words, the main initial loss of lithium in the system is due to its consumption as a building blocks (lithium oxide, lithium carbide and more) during SEI generation. This leads to increased resistivity during cycle life, and hence capacity drop.

(2) volume expansion during charging, causing SEI break on the active material. This in turn exposes the surface of new active material to the electrolyte solution, and hence as before, causes a massive and constant re-built of SEI layers. e.g. increased internal resistance, low ionic transport, and reduced cycle life and capacity with each cycle.

(3) low diffusivity of Li which necessitates small size active material particles (<150 nm in Silicon) to ensure a low interaction path and which requires full exploitation of the energy through lithiation of the active material. The low diffusivity and speed of Li—Si bond forming/breaking in comparison with Si—Si bond forming/breaking results in the formation of cracks and breaking of the active material. As a result, in each cycle more surface area is exposed to SEI built, electrical disconnection of the particles from the rest of the active material, and as indicated above—results in an increase in the internal resistance and fast capacity degradation.

These drawbacks are associated with the use of all metalloids, e.g., silicon, germanium, tin, lead and aluminum. When using silicon, these drawbacks limit the use thereof in the anode to up-to 5% commercially, balancing the increase of capacity needed with the cycle life.

Various solutions have been suggested, and are in practice, but with limited success. Coating of the active material with substances such as carbon which lowers, at least by, several cycles the direct interaction of the lithium ions in the electrolyte solution and the electrolyte solvent itself with the active material surface, which is highly reactive toward the electrolyte solution. Similarly, adding additives to the electrolyte solution, such as FEC (Fluoroethylene carbonate). LiNO₃, LiSiO₃, methylene ethylene carbonate (MEC) etc assists in building a more flexible SEI (FEC for example), and/or reduces the polymerization of the electrolyte solution (such as LiNO₃, LiSiO₃). A different approach is to use lithium ion conductive binders which coat the active material and change its form along with the active material expansion/retraction mechanism during charge and discharge operation. This is typically done alongside limiting the access of the electrolyte solution from a direct contact with the active material.

Yi Cui et-al [1] proposed in situ polymerization of a conducting hydrogel (PANi, Polyethylene imide) which, according to the authors, uniformly coats the silicon nanoparticles, exhibiting thousands of cycles in a half-cell (silicon anode vs. lithium), with high rate capability. Nevertheless, the first cycle efficiency is reported to be very low (70%), and it takes more than 300 cycles to stabilize the columbic efficiency over 99%, i.e. side reaction still exists. The in situ polymerization is essential in this technology due to the need to form a good coating around the active material.

Jonathan N. C. et-al [2] demonstrate the use of PEDOT:PSS to form a coating around the active material. The first cycle efficiency is still low (78%) and the cyclability performance suffers from a fast drop from the initial capacity to approx. 60% at the first few cycles before some stabilization occurs.

Yang-Tse Cheng et-al [3] reports a system with silicon nanoparticles using Nafion as binder exhibiting high capacity, nevertheless suffers from the same low first cycle efficiency.

Low first cycle efficiency and low total efficiency are typically due to factors such as contact between the electrolyte solution and the active material and a large surface area of the ion conductive polymer. Both are highly reactive towards the electrolyte solution, resulting in SEI formation. In other words, the initial capacity is a sum of the metalloid internal capacity with lithium, together with the pseudo capacity measured due to the energy transfer during the SEI formation. Where the fraction of the energy loss due to the SEI formation in the sum above reduces from cycle to cycle, and where until this side reaction stops (or more likely becomes negligible), lithium in the system is transferred into a non-returnable lithium.

While this shows promising results in half-cell formations where there is an endless amount of accessible lithium source, these are yet in cases where lithium in the cathode is highly limited, and pre-lithiation is essential not only for the 1st cycle but also for the following several 10s to 100's of cycles.

U.S. Pat. No. 6,027,836 [4] discloses a non-aqueous polymer cell that contains a lithium ion conductive polymer having a porosity in the range of 10% to 80%. In the cell the electrolyte is held not only in the pores of the microporous polymer but also within the polymer itself.

### BACKGROUND ART

Yi Cui et-al; Nature Communications volume 4, Article number: 1943 (2013).

Jonathan N. C. et-al; ACS Nano 2016, 10, 3702-3713,

Yang-Tse Cheng et-al; Journal of The Electrochemical Society, 163 (3) A401-A405 (2016),

U.S. Pat. No. 6,027,836.

### GENERAL DESCRIPTION

The inventors of the technology disclosed herein have developed a methodology that cures the deficiencies of the art and provides a novel energy storage system that makes use of a novel ion conductive assembly and electrodes.

It is a first purpose of the present invention to provide an ion conductive assembly (ICA) which comprises at least one electrode (an anode or a cathode, or both, or an electrode assembly) and a separator layer. More specifically, the invention provides an ion conductive assembly (ICA) comprising a plurality (two or more) of material regions, said plurality of material regions being linked by a polymeric amorphous network of at least one ion conductive material, wherein in a first region (of the two or more or plurality of regions) defining an electrode (which may be an anode or a cathode), the ion conductive material is of a porosity up to 20% and comprises a plurality of active materials fully embedded within the ion conductive material, and wherein

in a second region defining a separator, the ion conductive material is of a porosity of between 0 and 80%, and free of active materials and electron conductive additives.

The number of material regions in an ICA according to the invention may vary based on the structure of the device. Typically, the number of material regions is at least two, or the number of material regions is two or three or four, etc. In some embodiments, the number of material regions is two or three. Where the number of regions is two, one of the two regions is an electrode (anode or cathode) and the second of the two regions is a separator region, as defined. Where the number of regions is three or three or more, one of the three (or three or more) regions is an electrode and a second of the three (or three or more) regions is a separator region, as defined. The nature of the third (or further) region may vary. In some cases, where the number of material regions is three (or more), one region is an anode, a second region is a cathode and a third region is a separator that is interposed (positioned) between the anode and the cathode. The plurality of material regions, as further disclosed herein, are linked by a polymeric amorphous network.

As noted herein, the first region, being the electrode region, is differentiated from the second region, namely the separator region, by a degree or level of porosity that is up to 20% (the porosity being different from zero) for the electrode region and is between 0 and 80% for the separator region.

The “degree or level of porosity” refers to the fractional area of the region that is composed of pores, e.g., material-free areas, from the total area of the region, as a percentage between 0 and 20% or between 0 and 80%, as defined. The porosity of a region may be determined by any conventional means available in the art or may be calculated based on measurements as below. The porosity may be calculated by:
measuring weight per cubic cm and thickness of the material to give a gr/cm³ value—the so-called observed density;
determining the bulk density of the material, e.g., based on values provided in the art—the so-called bulk density; and
calculating the porosity (in % values) using:

$$100 - ( 100 \times \frac{observed density}{bulk density} ) = \% porosity$$

In cases when the observed density of the material equals the bulk density of the material, the porosity is regarded at zero percent (0%). Similarly, when the observed density is 80% of the bulk density, the porosity is 20%, when the observed density is 50% of the bulk density, the porosity is 50%, and when the observed density is 20% of the bulk density, the porosity is 80%.

The expression “up to 20%” refers to a degree or level of porosity that is lower than 20%, but may also be 20%. In some embodiments, the porosity of the two regions may be same or different. Wherein the degree or level of porosity is of each of the regions is the same or of a similar value, the regions are distinguishable from one another by the presence or absence of active materials and electron conductive additives. In other words, the first region, being the electrode region, and the second region, being the separator region, may be each characterized by a similar or identical porosity level (i.e., wherein the porosity of one is between 0% and 20% and of the other is between 0% and 80%), and differentiated one from another by one or more active materials or electron conductive additives that are present in one and absent in the other (or present in different amounts in both regions).

In some embodiments, the level of porosity of the electrode region is between 0 and 20%, 0 and 19%, 0 and 18%, 0 and 17%, 0 and 16%, 0 and 15%, 0 and 14%, 0 and 13%, 0 and 12%, 0 and 11%, 0 and 10%, 0 and 9%, 0 and 8%, 0 and 7%, 0 and 6%, 0 and 5%, 0 and 4%, 0 and 3%, 1 and 20%, 1 and 19%, 1 and 18%, 1 and 17%, 1 and 16%, 1 and 15%, 1 and 14%, 1 and 13%, 1 and 12%, 1 and 11%, 1 and 10%, 1 and 9%, 1 and 8%, 1 and 7%, 1 and 6%, 1 and 5%, 1 and 4%, 1 and 3%, 1 and 2%, 5 and 20%, 5 and 15%, 5 and 10%, 10 and 20%, or 10 and 15%. In some embodiments, the degree of porosity of the electrode region is below and different from 20%, wherein the minimum porosity is 0%.

The separator has a porosity of 0 and 80%. In some embodiments, the porosity is greater than 0% but is different from 20%. In some embodiments, the separator porosity is between 0 and 80%, 0 and 75%, 0 and 70%, 0 and 65%, 0 and 60%, 0 and 55%, 0 and 50%, 0 and 45%, 0 and 40%, 0 and 35%, 0 and 30%, 30 and 80%, 40 and 80%, 50 and 80%, 60 and 80%, 70 and 80%, 30 and 70%, 30 and 60%, 30 and 50%, 30 and 40%, 40 and 80%, 40 and 70%, 40 and 60%, 50 and 80%, or 50 and 70%. In some embodiments, the level of porosity is between 40 and 60%.

As noted hereinbelow, compression the materials under different conditions can afford porosity of a variety of sizes.

The innovative ICA of the invention can be used with any kind of electrode (anode and/or cathode) material composition and/or separator material composition where it offers the following advantages over known technologies:
Lowering the amount of liquid electrolyte needed and hence increasing safety.
Increasing volumetric capacity by decreasing the pores' total volume.
Prolonging cycle life and stability.

The ICA can be expended to all-solid-state or semi-solid-state full cells. The ICA can be further used as energy storage binders for electrodes and/or separators.

As stated above, the electrode and the separator are linked by a polymeric amorphous network of an ion conductive material (hereinafter “ion conductive continuous phase” or “continuous phase”), which, at a region defining the electrode, is of low porosity (below or up to 20%) and comprises a plurality of active materials, e.g., in particulate form(s), that are fully embedded within the continuous phase. At a region defining the separator, the continuous phase comprises high porosity (being as high as 80% in certain embodiments) and is free of active materials and electron conductive additives. This region characterized by high porosity and absence of active materials is hereinafter referred to as the “porous phase”.

Both the continuous phase and the porous phase exhibit material continuity. Independent of whether or not both phases (the region defining the electrode and the region defining the separator) are formed of the same or different material(s), a clear boarder defining the limits of both phases cannot be established. Both phases are adhesively associated such that mechanical separation is not possible.

As used hereinabove, in some embodiments, the ion conductive material of the first region (the electrode) is the same as the ion conductive material of the second region (the separator). In some other embodiments, the ion conductive material of the first region is different from the ion conductive material of the second region.

Unlike the separator (the porous phase), the electrode of the invention is constructed of a low porosity continuous ion conductive polymeric material, which defines an ion mobility path, and one or more active materials, e.g., in the form of particles, that are embedded, encapsulated, coated or surrounded by the polymeric material. The electrode is configured to allow ion mobility through the low porosity continuous phase towards the active material. In such a mosaic, where the active material is embedded in the conductive polymer surroundings, the active material is protected from direct contact with any fluid contained in the porous phase, e.g., an electrolyte solution. This protective feature increases or greatly improves the efficiency of the ICA as an ion conductive layer and as an electronic conductive layer.

The low porosity of the continuous phase allows the active particles to go through a volume change in the lithiation/delithiation (Li/DeLi) cycles without experiencing substantial mechanical degradation, while maintaining their protection/isolation from the porous phase. This limits formation of extensive solid electrolyte interface (SEI) build up and holds any possible fragments in close proximity. However, at the same time—the low porosity of the electrode presents a problem in terms of cell functionality. When lithium-ion batteries are concerned, due to the inherent need for an electrolyte solution to allow efficient transport of lithium ions directly to the active material, the porosity of the continuous phase must be selected to, on one end, permit effective transport of the ions to the active materials and, at the same time, prevent wetting of the active materials. Too low a porosity causes a reduction in the effective surface area available for such interaction, and hence increases internal resistance (i.e., reduces the energy efficiency of the system since part of the energy is translated into heat due to the resistance). Low porosity also reduces the apparent capacity as some of the active material is not accessible to the lithium ion flux, and hence promotes faster degradation of the electrode and the cell as a whole.

At low C rates (low currents, low flux) the ionic transport becomes available, while at higher C rates (higher currents, higher flux) the ionic transport becomes reduced due to blocking, hence even faster degradation occurs. During charging, metallization forms on the electrode since more ions arrive to the available liquid/solid interface than capable to penetrate into the active material. In other words, the rate of lithium ions transport to the solid/electrolyte interface is larger than the rate of lithium ion transport into the active material, while the rate of lithium reduction increases and hence lithium ions are reduced to metal lithium on the available surface area.

In the ICA of the invention, de-solvation of the lithium ions occurs mostly at the interface (the separation region, the separator) between the electrolyte solution and the ion conductive polymer, where the ions then transport via the ion conductive polymer to the active material in a partially charged mode, which reduces the probability for metallization.

The continuous phase in an electrode of the invention is constructed of at least one highly ion conductive substance that display low electronic conductivity. In some embodiments, the ion conductive substance is at least one ion conductive polymeric material, as further detailed herein. Non-limiting examples of the ion conductive polymers may be selected from polyethylene oxide (PEO), polyvinyl alcohol (PVA), polyethylene imine (PEI), lithium polyacrylic acid (LiPAA), polyacrylic acid (PAA), lithium polyphosphate (LiPP), poly ammoniumphosphate (APP), polyphosphates, polyvinylpyrrolidone (PPy), polysaccharide-based polymers, such as carboxymerhyl cellulose (CMC), lithium alginate (LiAlg), alginate (Alg), methyl-cellulose (MC) and sulfonated cellulose (SC) and any derivatives or combinations thereof.

The material(s) of the continuous phase does not promote SEI formation on their surface, so that the first cycle efficiency in lithium ion battery remains as high as possible. The electrodes can also combine other ion conductive materials which exhibit electronic conductivity. Such materials may be, for example, PEDOT:PSS, PANi. Nafion, which can be integrated in the matrix as co-binders and/or as possible pre-coating materials for the active materials. The electrode can also combine additional non-conductive polymers, with a total of less than 5% of the electrode material, to promote better adhesion and cohesion, if necessary. Such polymers may be, for example, polyvinylidene fluoride (PVDF), styrene butadiene (SBR) and others.

According to certain embodiments of the invention the active material particles are selected based on the function of the ICA. An electrode of the ICA can be made from highly ion conductive materials and very low electronic conductive continuous phase, which connects the active material particles and the conductive additives.

Where the electrode is an anode, the active material may be selected from a group of materials which can adsorb cations such as, but not limited to lithium, by for example intercalation or alloying. The active material is typically provided in the form of particles which may be selected from microparticles, nanoparticles, nanotubes, nanowires or of any other nanometric architecture.

The active material may be of a material selected from carbonaceous materials such carbon allotropes, e.g., graphite, graphene, CNT, carbon black, and others; and elemental materials such as silicon, germanium, tin, lead, aluminum, and/or their oxides. Non-limiting examples of such materials include graphite of any type, composite graphite material of any kind, silicon nanoparticles (SiNP) or nanowires (SiNW) of any morphology, composite anode material of any kind, such as silicon-graphite, silicon-carbon, silicon oxide, and any metalloid-carbon (of any form, such as graphene etc.) and/or metalloid-graphite, germanium nanoparticles or nanowires, tin nanoparticles or nanowires, lithium nanoparticles, lithium microparticles and any combination thereof.

The active material particles may be selected from conductive carbonaceous materials such as, but not limited to, carbon black (such as Super C45, Super C65). Single walled carbon nanotubes (SWCNTs), multiwalled carbon nanotubes (MWCNTs), Graphite, tungsten carbide and others.

Where the electrode is a cathode, the active material may be selected from lithium salts such as LiFePO₄ (lithium ferro phosphate), lithium nickel manganese cobalt oxide (NMC), lithium nickel cobalt aluminum oxide (NCA), lithium nickel oxide (LNO), lithium cobalt oxide (LCO) and any combination thereof. The cathode may further comprise conductive additives such as carbonaceous materials, e.g., carbon black (such as Super C45, Super C65), SWCNTs, MWCNTs, Graphite, WC and others.

While the separator does not comprise active materials or electron conductive additives, it may comprise particles of ion conductive substances, ion conductive salts and further ceramic nano- or micro-particles. The purpose of these materials is to better ion conductivity, to act as lithium metal dendrite quencher (and hence afford better stability and higher safety) and/or provide a more rigid structure. The materials may be selected from titanium oxide, alumina, LiSiO₃, NASICON (such asNaM₂(PO₄)₃, where M is a cation; such a material may be NaₓZr₂SiₓP₃₋ₓO₁₂, where 0≤x≤3), garnet (such as Li₃Ln₃M₂O₁₂, where M=Te, W; Ln=Y, Pr, Nd, Sm, Eu, Gd, Tb, Dy. Ho, Er, Tm, Yb. Lu), perovskites (such as Li₃ₓLa_{2/3-x}TiO₃ (LLTO), wherein 0<=x<=2/3), LISICON (such as Li₁₄Zn(GeO₄)₄), LiPON, Li₃N, sulfides (such as Li₄₋ₓGe₁₋ₓPₓS₄, where 0<x<1), argyrodite (such as Li₆PS₅X, where X=Cl. Br, I), anti-perovskites (such as Li₃O(Cl_{1-z}Br_{z}), wherein 0<=z<=1), ion conductive salts (such as lithium perchlorate (LiClO₄), lithium-bis(oxalato)borate (LiBOB), lithium-oxalyldifluoroborate (LiODFB), lithium-fluoroalkylphosphate (LiFAP), lithium-bis(trifluoromethanesulfonyl)imide (LiTFSI), and salts of Li⁺[R₁—SO₂NSO₂—R₂]⁻, wherein each of R₁ and R₂, independently of the other, may be —CF₃, —CF₂H, —CFH₂ or —CH₃.

Unlike the known uses of ionic conductors which are also somewhat electronic conductors, in the electrode of the invention SEI formation on the active material surface is greatly reduced, thereby also reducing lithium loss. Furthermore, due to the low porosity of the electrode, the liquid electrolyte in the porous phase cannot reach every part of the continuous phase (continuous phase), thus the reactive surface area of the binder in the electrode is reduced in comparison to commonly used binders, without compromising the needed ionic mobility. This also enables the use of smaller amounts of the electrolyte solution as compared to regular lithium ion batteries since the mosaic electrode (anode or cathode) can hold much less electrolyte solution than a regular electrode.

The electrode is highly effective mainly when using metalloids as active materials, since this highly ionic conductivity serves as an artificial SEI layer which protects the active material from liquid electrolyte solutions, and hence further increases the first cycle efficiency and reduces the adverse side reactions and the lithium consumption. Due to the flexibility of the ion conductive materials, any expansion and/or break of the active material during cycling, is absorbed within the matrix of the electrode, with a minimal (if any) exposure of the newly formed active material surfaces to the electrolyte solution, and hence additional SEI formation is limited. Since these breakings occur in highly ion conductive surroundings, the limited loss of effective surface area is minimal during the process. Furthermore, since the conductive additives are also embedded in this continuous layer, the SEI formation on top of them is also limited to negligible.

The use of the ICA of the present invention gives rise to systems with a high first cycle efficiency, higher cycle life, and limits the need for pre-lithiation, in comparison to known technologies. The ICA further allows for the use of metalloids as anodes in much higher concentrations in the anodes than current practices.

Electrode compositions of the invention may be selected as depicted in Scheme 1 below. As depicted in Scheme 1, an active material may be selected with a conductive additive material and a conductive polymer to provide an ion conductive phase. For example, graphite may be used as an active material alone with PEI as the ion conductive polymer with CNTs as conductive additives.

In Schemes 1 and 2, the gray lines indicate possible material selection for anode electrodes, and the black lines are for cathode electrode area. Dashed lines are optional additions. It is to be noted that anodes and cathodes having the configuration disclosed herein can exist independent one of the other, but can be combined for forming a path for ions from the anode to the cathode and vice versa.

The present invention further provides a method for producing an ICA of the present invention. In a typical preparation procedure, an electrode, being an anode or a cathode, is prepared using an ion conductive binder. The method includes preparation of slurry comprising an active material and an ion conductive polymer. The slurry may further comprise at least one binder, optionally in the form of one or more additional polymer. The slurry may be pre-prepared or may be formed just before the ICA is fabricated.

The slurry is first spread (e.g., by using Dr. blade) on a substrate being, in some embodiments, a battery grade copper foil for anodes, or battery grade aluminum foil for cathodes, dried, and then pressed to achieve a porosity smaller or equal to 20%. In general, porosity control can be achieved by using, for example, hot roll press (calandering machine), or any other press mechanism known to art. Additional control over the porosity before and/or after pressing, or without press, can be achieved by ultrasonic cavitation, direct printing mechanism, or controlled electrophoretic deposition.

After the electrode is formed, a separator film (being the separation area discussed herein) is formed on the electrode film by, e.g., spreading, a highly lithium ion conductive polymer. The conductive polymer may or may not be the same used in the anode and/or the cathode. The separation area may further comprise ceramic particles of a material such as titanium oxide, aluminum oxide, and others, as detailed herein. Once the separator film is formed and subsequently dried, the separator film exhibits a porosity of between 20% and 80%. In some embodiments, the porosity is between 40 and 60%.

Thus, a method of the invention comprises:
forming the electrode (anode or cathode) as a thin film having a porosity up to 20%, as defined herein, on a substrate, being a metal film, or any other electron conductive substrate (in some embodiments, the film being 1 to about 150 micrometer thick); and
forming a separator film on said electrode, the separator film having a porosity between 20% and 80%, or between 40 and 60%.

In some embodiments, the method comprises obtaining a slurry comprising an active material and an ion conductive polymer. In some embodiments, the slurry further comprises at least one additive such as at least one binder, at least one surfactant, at least one deflocculant and optionally other additives, wherein the additives are optionally in the form of one or more additional polymer. In some embodiments, the at least one surfactant acts as a deflocculating agent such as sodium hexametaphosphate (SHMP).

In some embodiments, the slurry is formed by adding conductive additives into a dissolved binder solution, followed by adding the active material.

In some embodiments, the slurry is formed by gradually adding conductive additives into a dissolved binder solution while mixing at low speed (>100 rpm), then mixing at 1200 rpm for 1 hour (premix stage) then gradually adding the active material during slow mixing (>100 rpm), followed by 1 hour mixing at 1200 rpm. Then mixing is continued at 600 rpm (kneading).

In some embodiments, in an electrode film formed according to the invention, the amount of the active material is between 85 and 95%, conductive additive between 0.5 and 3%, and conductive polymer/binder in an amount between 1 and 12% (w/w).

In some embodiments, where the active material is silicon, the amount thereof is between 40 and 70%, the amount of the conductive additive is between 10 and 40%, and the amount of the ion conductive binder is between 10 and 40% (w/w).

In some embodiments, in an electrode film formed according to the invention, the amount of the active material is 93%, conductive additive 2%, and conductive polymer/binder 5% (w/w).

The electrode film is formed to reduce the pores in the film to a bare minimum. Generally, the porosity of the electrode film is below or up to 20%. In some embodiments, it is below 19, 18, 17, 16, 15, 14, 13, 12, 11, 10, 9, 8, 7, 6, 5, 4, 3 or 2%.

The low porosity is typically achieved by spreading the slurry on the substrate, e.g., metallic substrate, and pressing the spread slurry to achieve the required porosity. The measurements performed for estimating porosity include electrode thickness (without the current collector) and electrode weight per unit area. The initial (e.g. after spreading and drying) porosity is usually between 45% to 70%. Calculation is done for the thickness of the electrode needed to receive, with the same weight per area, the required porosity. The roll press is set to the required thickness (which is smaller than the initial thickness) and the electrode is passed through.

Alternatively to spreading, the slurry may be applied onto the substrate by any one of the following methods printing (of any kind), electrophoretic deposition (EPD), electromagnetic depositing (EMD) when the particles are, or coated by ferromagnetic substance, spin coating, atomic layer deposition (ALD) and others.

In some embodiments, the electrode comprises multiple material films. In other words, in some embodiments, a method of the invention comprises forming a first electrode film on a substrate, drying said first electrode film: applying a further amount of a slurry (same or different from the slurry of the first electrode film) on the dried first electrode film, drying same and repeating one or more times to obtain the multilayer. On the top most electrode film, the separator film may be formed.

The method of the invention further provides a method for constructing an electrode assembly (or a hybrid electrode) comprising both an anode and a cathode. In accordance with a method of the invention, either an anode or a cathode may be formed as described herein, followed by forming a separator film on the electrode. Subsequently, the separator film may be coated with a material composition (a slurry) of the opposite electrode. This method may thus comprise:
forming either an anode or a cathode electrode as a first thin film having a porosity below 20%, as defined herein, on a substrate, being a metal film, or any other electron conductive substrate (in some embodiments, the film being 1 to about 150 micrometer thick);
forming a separator film on said anode or cathode, the separator film having a porosity between 20% and 90%; and
forming the other of said anode or cathode electrode as a second thin film on the separator film, wherein the second thin film having a porosity below 20%.

In some embodiments, the first thin film is an anode film and the second thin film is a cathode film. In other embodiments, the first thin film is a cathode film and the second thin film is an anode film. In such an assembly, the ion conductive polymer making up the separator may be the same as the ion conductive polymer of either or both the anode and cathode film, or may be different from both.

Each of the anode and cathode electrodes has its own current collector. The deposition of the films can be in sequence. In some embodiments, an LBL method may be applied in which a 1^{st} electrode on current collector, followed by separation layer, flowed by 2^{nd} electrode and ending with the 2^{nd} current collector which can be deposited by any method from printing, to spreading or attaching. Alternatively, the 1^{st} electrode is deposited on its current collector, following by separation area depositing. The 2^{nd} electrode is similarly associated with a current collector, and then the two separator@electrode films are attached together by adhesion.

The separator film is adhesively associated with the electrode film such that the two films are mechanically inseparable. To achieve adhesion, the separator is formed by applying a solvent mixture comprising of at least one ion conductive polymer. The ion conductive polymer used may be the same or different from that used in the electrode.

In general, in forming both the electrode and separator films, a desired porosity can be achieved by using, e.g., a hot roll press (calendaring machine), or any other press mechanism known in the art. Additional control over the porosity before and/or after pressing, or without press, can be achieved by ultrasonic cavitation, direct printing mechanism, or controlled electrophoretic deposition. Controlling the porosity before and/or after pressing, or without press, can also be achieved by ultrasonic cavitation. Theoretical calculation for porosity estimation is based on the bulk density of the substances. The measurements done for this estimation are electrode thickness (without the current collector) and the weight per unit of area. The initial (e.g., after spreading and drying) porosity is usually between 45% to 70%. Calculation is done for the thickness of the electrode needed to achieve, with the same weight per area, the required porosity. When roll pressing is used, it is set to the required thickness and the electrode is passed through to receive the desired electrode thickness which is matching the desired porosity.

Further provided by the present invention is an energy storage device comprising ICA of the present invention.

The energy storage device of the invention comprises at least one energy cell. The energy cell may comprise an electrode of the invention, which may be in a form of anode and/or a cathode or an hybrid electrode (an assembly of both an anode and a cathode separated by a separator, as disclosed herein) and an electrolyte solution. In some embodiments, the energy cell comprises an anode or a cathode constructed as disclosed herein. In some embodiments, the energy cell comprises a hybrid electrode, as disclosed herein.

In a cell of the invention, the electrolyte solution comes into contact with the separator or in the case of the hybrid electrode with the separation area and has little or no interaction with the active material present in the electrode.

As known in the art, an energy storage device is a device that stores energy for later use. The device is typically a battery that may be chargeable or non-rechargeable. The devices of the invention may be selected from lithium batteries, sodium batteries, magnesium batteries or any other battery and combination thereof.

The invention additionally provides a lithium battery comprising an ICA of the invention. The electrode film in the ICA of the lithium battery is an anode.

The invention also contemplates an electrode comprising a low porosity continuous ion conductive polymeric material and one or more active materials, as disclosed herein. The electrode may be one comprising a current collector having on at least a region thereof a film of at least one ion conductive material having a porosity below 20% and comprising a plurality of active materials fully embedded within the ion conductive material, the film of the at least one ion conductive material being configured to surface associate to a separator film comprising at least one ion conductive material, having a porosity of between 20 and 80%, and being free of active materials and electron conductive additives.

In some embodiments, the electrode is an anode.

The electrode of the invention may be used in fabricating an ICA of a structure defined herein or any other generic ICA as may be known in the art.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-B provide schematic depictions of an anode according to the invention. FIG. 1A is a general schematic depiction of anode and an ion conductive separator in a LPML structure. FIG. 1B is a theoretical representation of an ion flux in an anode structure having an ion conductive separator in a LPML structure of the invention.

FIG. 2 is an image of an anode and an ion conductive separator in a LPML structure.

FIGS. 3A-C provide: FIG. 3A—a PVDF-based anode half-cell with and without ICM (Example 1b & Example 3). First formation cycle at 0.03C. FIG. 3B—a PVDF based anode half-cell with and without ICM (Example 1b & Example 3). Last formation cycle at 0.1C. FIG. 3C—a PVDF based anode half-cell with and without ICM (Example 1b & Example 3). Formation cycles coulombic efficiency: regular stabilization is seen in all samples; however, the least stable is when the porosity <10%, and the separator is a regular separator. Electrolyte: 1.1 M LiPF₆ in EC:EMC (3:7) 1 % (w/w) LiPO₂F₂, 1% (w/w) VC. When regarding to Regular separator: 12 um thickness Polypropylene separator.

FIGS. 4A-D provide: FIG. 4A—a CMC based anode half-cell with and without ICM (Example 1a & Example 4). First formation cycle at 0.03C. FIG. 4B—a CMC based anode half-cell with and without ICM (Example 1a & Example 4). Last formation cycle at 0.1C. FIG. 4C—a CMC based anode half-cell with and without ICM (Example 1a & Example 4). Formation cycles coulombic efficiency: regular stabilization is seen in all samples. FIG. 4D—a CMC based anode half-cell with and without ICM (Example 1a & Example 4). Formation cycles efficiency relative to the first charge: In Both ICA samples at 30% and <10% porosity, the stabilization is in higher rate in compare with samples used regular separator. Electrolyte: 1.1 M LiPF₆ in EC:EMC (3:7) 1% (w/w) LiPO₂F₂, 1% (w/w) VC. When regarding to Regular separator: 12 um thickness Polypropylene separator.

FIG. 5 depicts the discharge capacity rate (%) vs cycle ID comparison between example 1a, 1b with regular separator and ICS separator at 0.5C cycling (cycles following the formation). Where the anodes are pressed to <10%, and with comparison to 30% porosity anode with ICS separator area. The stability of the ion conductive polymer-based binder anode with <10% anode porosity, and with ICS separator is the greatest in comparison with all <10% porosity anodes, and even better stability than 30% (regular) porosity anode. Electrolyte: 1.1 M LiPF₆ in EC:EMC (3:7) 1% (w/w) LiPO₂F₂, 1% (w/w) VC. When regarding to Regular separator: 12 um thickness Polypropylene separator.

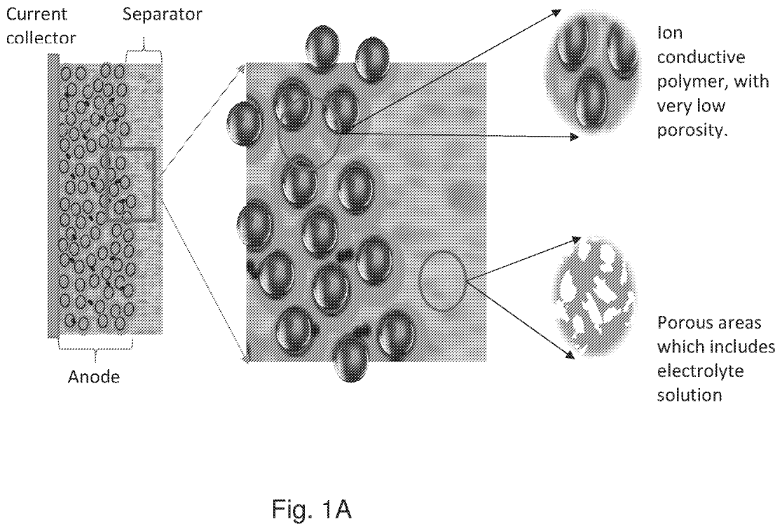

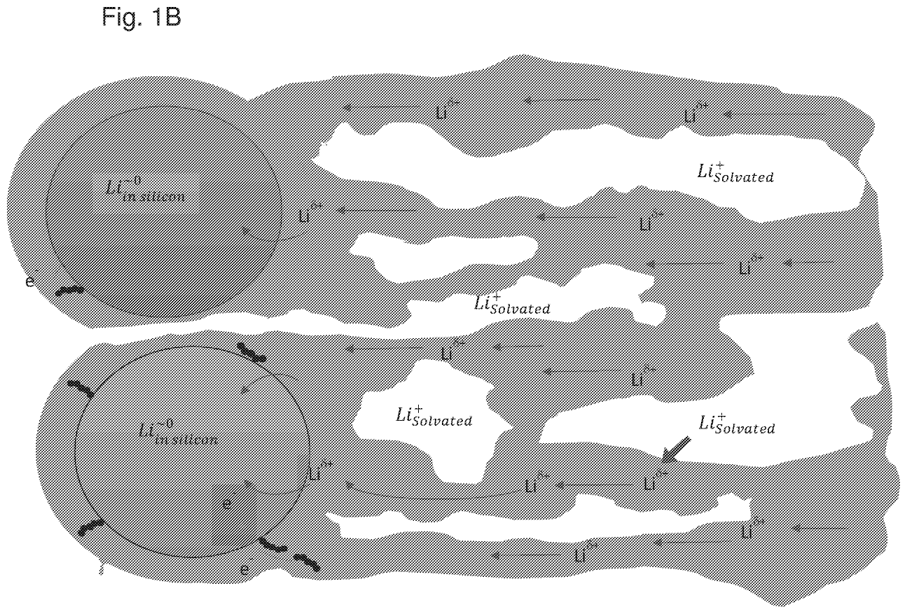

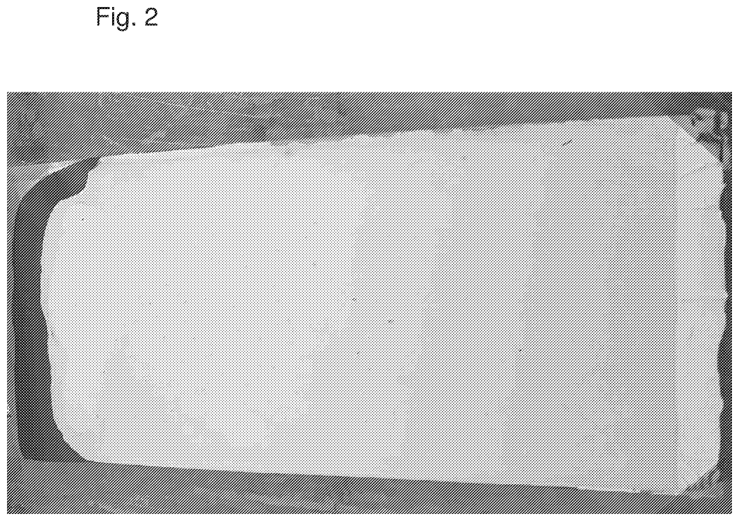

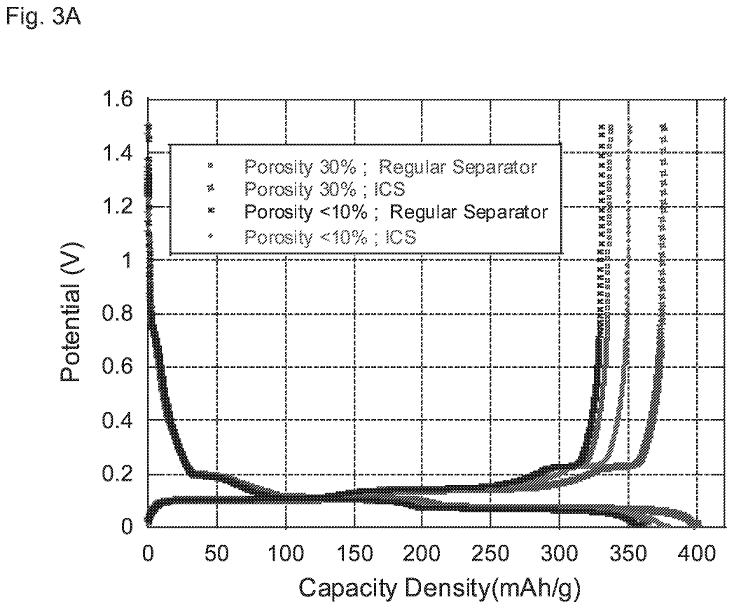

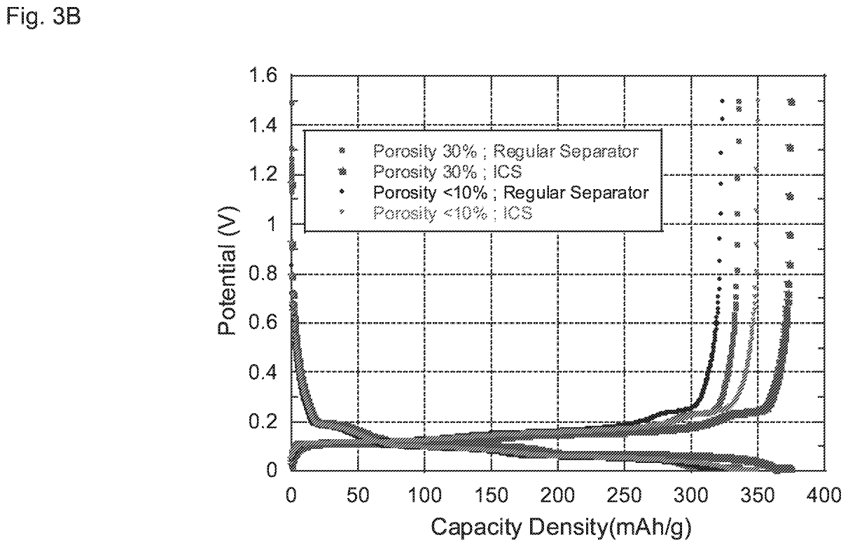

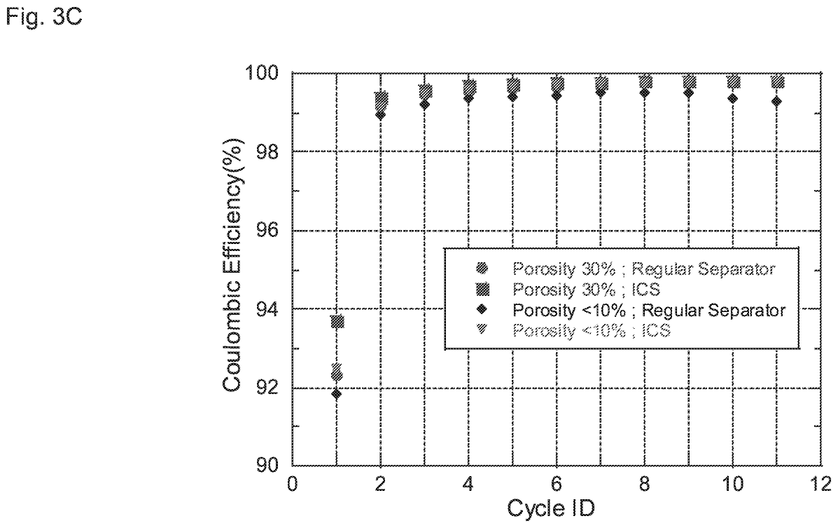

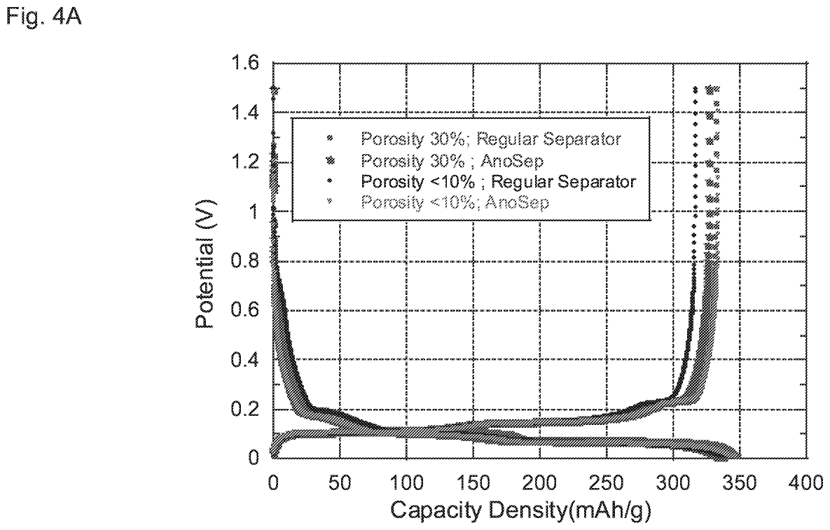

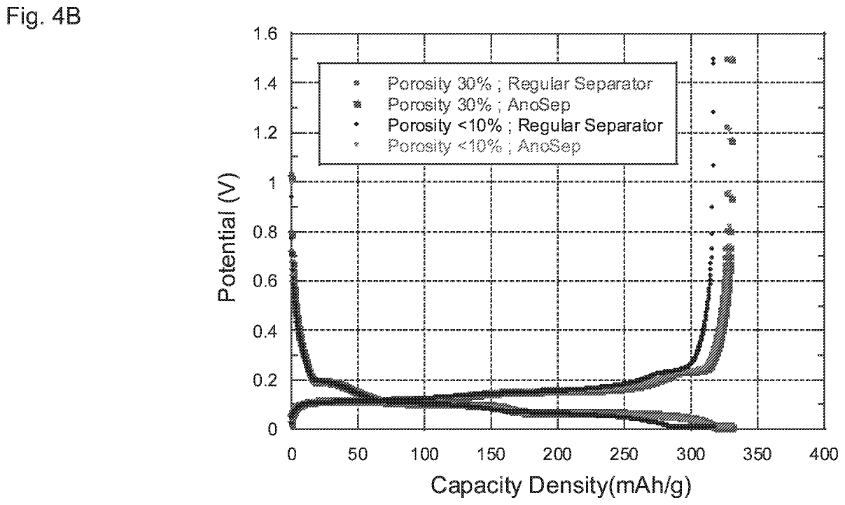

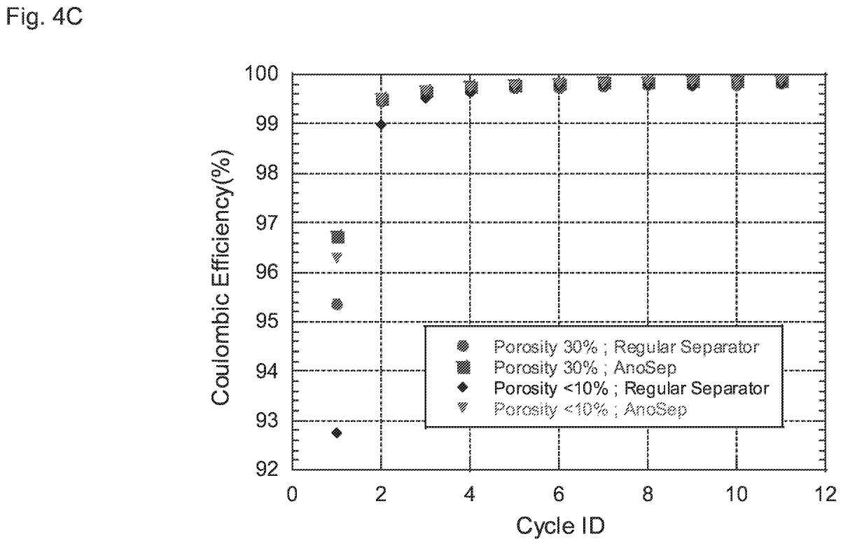

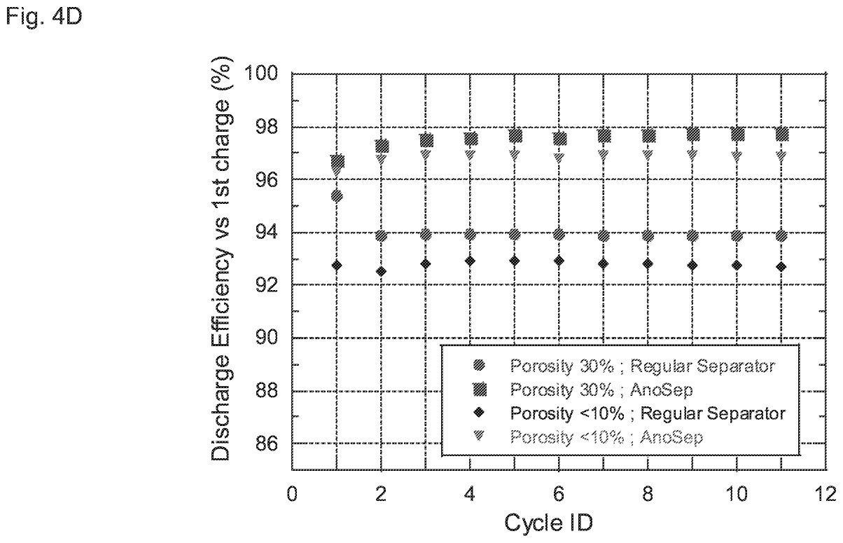

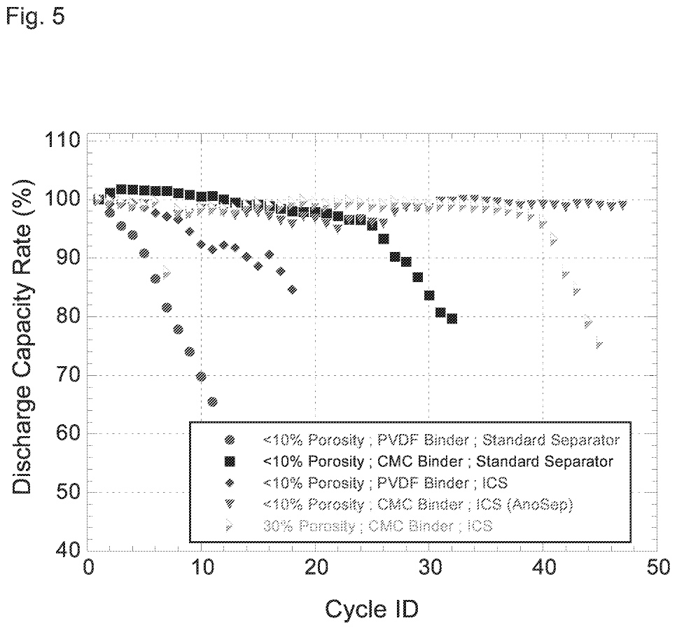

### DETAILED DESCRIPTION OF EMBODIMENTS

Further provided the present invention is where the electrodes and/or the separator area are made for the use in any kind of capacitors and/or hybrid capacitors.

### Example 1a —Anode Preparation with CMC 700K Binder

1.744 g of CMC 700K was added to 35 mL of 5% ethanol solution in double-distilled H₂O (2D-H₂O) while mixing, and then added 20 mL of 2D-H₂O and mixed to full dissolution. Then, 30 g of Graphite (Targray 807) was added while mixing in 4 fractions, followed by adding 2.79 g of Timcal SFG15L. Mixed for 1 hour and then 0.349 g of TIMCAL SC65 added followed by addition of 45 mL 2D-H₂O. The mixing continued then for 12 hours prior to spreading using automated “Dr. Blade” machine to give a final solid material load of 7.8 mg/cm². The result electrode has 86% Active material, 8% intermediate active material, 5% binder, and 1% conductive additive.

The spread anode was dried at 60° C. for 5 hours and then additional 12 hours at 100° C.

The resulting electrode was pressed to achieve a porosity of 30%, 7-8%, and <5% porosity.

### Example 1b —Anode Preparation with PVDF Binder

2.616 g of PVDF was added to a 50 mL of NMP while mixing until full dissolution. Then, 45 g of Graphite (Targray 807) was added while mixing in 4 fractions, followed by adding 4.185 g of Timcal SFG15L. The slurry was mixed for 1 hour and then 0.524 g of TIMCAL SC65 added. The mixing continued for 12 hours prior to spreading using automated “Dr. Blade” machine to give a final solid material load of 11.13 mg/cm². The resulting electrode had 86% active material, 8% intermediate active material, 5% binder, and 1% conductive additive.

Thus spread anode was dried at 80° C. for 4 hours, and additional 12 hours at 100° C.

The resulting electrode was pressed to achieve a porosity of 30%, and <10% porosity.

### Example 2—Preparation of Ion Conductive Separation Area 1 and ICA Using it

11.59 g of lithium alginate (high viscosity) 15 wt. % solution was added into 25 mL of 2D-H₂O, followed by addition of 0.1 g of sodium hexametaphosphate (SHMP) and well mixed to full dissolution. Then 20 g of 5-8 μm alumina particles were added, and mixed for 12 hours prior to use.

The mixture was spread on anodes prepared in Example 1 using a 405-micrometer gap “Dr. Blade”, dried at 80° C. for 1 hour, followed by drying at 100° C. for 12 hours prior to testing.

### Example 3—Preparation of Ion Conductive Separation Area 2 and ICA Using it

6.47 g of LiPAA 13 wt. % solution was added into 36 mL of 2D-H₂O, followed by addition of 0.2125 g of short ammonium polyphosphate (<100 units polymer) and 0.1 g of sodium hexametaphosphate (SHMP) and mixed to full dissolution. Then, 20 g of 5-8 μm alumina particles were added and mixed for 12 hours prior to use.

The mixture was spread on an anode prepared in Example 1 using a 405-micrometer gap “Dr. Blade”, dried at 60° C. for 1 hour, followed by drying at 100° C. for 12 hours prior to testing.

### Example 4—Preparation of Ion Conductive Separation Area 4 and ICA Using it

0.16 g of PVA (medium viscosity) was fully dissolved in 15 mL of 20% Ethanol in 2D-H₂O, then 0.81 g of 13 wt. % LiPAA solution was added into the PVA solution and well mixed until full dissolution. Following, 5 g of 5-8 μm alumina particles was added and mixed for 12 hours prior to use.

The mixture was spread on anodes prepared in Example 1 using a 230-micrometer gap “Dr. Blade”, dried at 60° C. for 1 hour, followed by drying at 100° C. for 12 hours prior to testing.

### Example 5—Preparation of Ion Conductive Separation Area 5 and ICA Using it

0.26 g of PVA (medium viscosity) was fully dissolved in 15 mL of 20% ethanol in 2D-H₂O, followed by addition of 5 g 5-8 μm alumina particles and mixed well for 12 hours prior to use.

The mixture was spread on an anode prepared in Example 1 using a 230-micrometer gap “Dr. Blade”, dried at 60° C. for 1 hour, followed by drying at 100° C. for 12 hours prior to testing.

### Example 6—Preparation of Ion Conductive Separation Area 6 and ICA Using it

0.26 g of PVA (medium viscosity) was fully dissolved in 15 mL of 20% Ethanol in 2D-H₂O. Followed by addition of 5 g 1-3 μm titanium oxide mixed well for 12 hours prior to use.

The mixture was spread on an anode prepared in Example 1 using a 230-micrometer gap “Dr. Blade”, dried at 60° C. for 1 hour, followed by drying at 100° C. for 12 hours prior to testing.

1. An ion conductive assembly (ICA) comprising a plurality of material regions, said plurality of material regions being linked by a polymeric amorphous network of at least one ion conductive material, wherein
in a first region defining an electrode, the ion conductive material is of a porosity between 0 and 20% and comprises a plurality of active materials fully embedded within the ion conductive material, and wherein
in a second region defining a separator, the ion conductive material is of a porosity of between 0 and 80%, and free of active materials and electron conductive additives.

2. (canceled)

3. The ICA according to claim 1, wherein the plurality of material regions is three material regions, the three material regions being an anode region, a cathode region and a separator region.

4. The ICA according to claim 1, wherein the plurality of material regions are linked by said polymeric amorphous network.

5. The ICA according to claim 3, wherein the cathode region and anode region are separated by the separator region, said regions being linked by said polymeric amorphous network.

6.-9. (canceled)

10. The ICA according to claim 1, wherein the plurality of active materials are particulate active materials selected from nanotubes, nanowires, nanoparticles and microparticles.

11. The ICA according to claim 10, wherein particulate active materials are embedded in the at least one ion conductive material such that direct contact between the particulate active materials and an electrolyte solution is prevented or minimized.

12. (canceled)

13. The ICA according to claim 1, wherein the electrode is constructed of an ion conductive polymer selected from, polyethylene oxide (PEO), polyvinyl alcohol (PVA), polyethylene imine (PEI), lithium polyacrylic acid (LiPAA), polyacrylic acid (PAA), lithium polyphosphate (LiPP), poly ammoniumphosphate (APP), polyphosphates, polyvinylpyrrolidone (PPy), polysaccharide-based polymers, lithium alginate (LiAlg) and alginate (Alg) or any combination thereof.

14. (canceled)

15. The ICA according to claim 1, further comprising at least one electronic conductive ion conductive material and/or at least one non-conductive polymer.

16.-30. (canceled)

31. The ICA according to claim 1, wherein the separator further comprises ion conductive substances and/or ion conductive salts, or wherein the separator further comprises ceramic nano- or micro-particles.

32.-33. (canceled)

34. The ICA according to claim 31, wherein the ion salts are selected from lithium perchlorate (LiClO₄), lithium-bis(oxalato)borate (LiBOB), lithium-oxalyldifluoroborate (LiODFB), lithium-fluoroalkylphosphate (LiFAP), lithium-bis(trifluoromethanesulfonyl)imide (LiTFSI), and salts of Li⁺[R₁—SO₂NSO₂—R₂]⁻, wherein each of R₁ and R₂, independently of the other, may be —CF₃, —CF₂H, —CFH₂ or —CH₃.

35. The ICA according to claim 1, wherein the separator comprises a material selected from titanium oxide, alumina, LiSiO₃, NASICON, garnet, perovskites, LISICON, LiPON, Li₃N, sulfides, argyrodite and anti-perovskites.

36.-46. (canceled)

47. A method for producing an ICA according to claim 1, the method comprising
forming an electrode film, onto a current collector surface, the film being of a slurry comprising at least one ion conductive material, optionally in a polymeric form, at least one active material and at least one binder, and applying pressure to said film to achieve a compressed electrode film having a porosity smaller or equal to 20%,
forming a separator film of at least one ion conductive material on the compressed electrode film, and applying pressure to said separator film to achieve a compressed separator film having a porosity of between 20% and 80%.

48.-55. (canceled)

56. The method according to claim 47, wherein the electrode film is formed by spreading the slurry on the current collector surface or by applying the slurry to the substrate by a method selected from electrophoretic deposition (EPD), electromagnetic depositing (EMD), spin coating and atomic layer deposition (ALD).

57. The method according to claim 47, for forming an ICA comprising an anode and an anode current collector, a cathode and a cathode current collector and a separator, wherein the separator is interposed between said anode and said cathode, the method comprising
forming a first electrode film, onto a current collector surface, the first film being of a slurry comprising at least one ion conductive material, optionally in a polymeric form, at least one active material and at least one binder, and applying pressure to said first electrode film to achieve a compressed first electrode film having a porosity smaller or equal to 20%, wherein the first electrode film is an anode film or a cathode film;
forming a separator film of at least one ion conductive material on the compressed first electrode film, and applying pressure to said separator film to achieve a compressed separator film having a porosity of between 20% and 80%;
forming a second electrode film, onto the compressed separator film, the second electrode film being of the other of anode film and cathode film and comprising at least one ion conductive material, optionally in a polymeric form, at least one active material and at least one binder, and applying pressure to said second electrode film to achieve a compressed second electrode film having a porosity smaller or equal to 20%.

58. The method according to claim 57, wherein the first electrode film is an anode film and the second electrode film is a cathode film, or wherein first electrode film is a cathode film and the second electrode film is an anode film.

59. (canceled)

60. The method according to claim 47, wherein compression of the electrode film and/or separator film is achieved by a hot roll press.

61. An energy storage device comprising ICA according to claim 1.

62.-66. (canceled)

67. A lithium battery comprising an ICA according to claim 1, wherein the electrode film is an anode film.

68. (canceled)

69. An electrode comprising a current collector having on at least a region thereof a film of at least one ion conductive material having a porosity between 1 and 20% and comprising a plurality of active materials fully embedded within the ion conductive material, the film of the at least one ion conductive material being configured to surface associate to a separator film comprising at least one ion conductive material, having a porosity of between 20 and 80%, and being free of active materials and electron conductive additives.

70. (canceled)

71. An ICA comprising an electrode according to claim 69.

72. (canceled)
